(19) United States
(12) Patent Application Publication
(10) Pub. No.: US 2005/0271040 A1
(43) Pub. Date: Dec. 8, 2005

(54) Centralized resource manager and resource conflicts in a home area network

(76) Inventors: Nick Schmidt, Brookline, MA (US); Gordon Landis, Stow, MA (US); Carlton J. Sparrell, Marblehead, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/120,293

(22) Filed: May 2, 2005

Related U.S. Application Data
(60) Provisional application No. 60/566,640, filed on Apr. 30, 2004.

(51) Int. Cl. H04L 12/66

(52) U.S. Cl. 370/352

(57) ABSTRACT

A content resource manager (CRM) in a home area network is configured to determine if a conflict exists between current use of a media pipeline and a requested use of the media pipeline. If a conflict exists, the CRM requests the user to indicate if a current use of a media pipeline should be discontinued and the desired program retrieved. The CRM may provide the user with a plurality of media pipelines to select from to override over which the desired program may be provided.

This application claims the benefit of 60/566,640 filed Apr. 30, 2004, herein incorporated by reference in its entirety.

### FIELD OF THE INVENTION

This invention relates managing resources in a home area network (“HAN”). More particularly, this invention relates to resolving conflicts for requests for utilization in a HAN.

### BACKGROUND OF THE INVENTION

Previously known HAN devices typically alert a user requesting a live session (e.g., involving the streaming of media data in real-time) of a conflict relating to the required resources (e.g. tuners) when a pre-scheduled recording is about to initiate. Typically, the user has an option of either terminating the scheduled recording (or choosing from a list of currently scheduled recordings) and returning to live TV or allowing the scheduled recordings to take place and choosing to watch either pre-recorded content or live content being recorded as part of the scheduled recordings.

With a centralized resource manager or CRM, multiple simultaneous live sessions may be active, and these sessions may be using resources located anywhere on the network. When a scheduled recording begins, the recording process expects access to resources previously reserved from the CRM. If those resources are in use, the other application using the resource(s) is typically obliged to release them. In one implementation, the reservation is made for specific resources, and the other application using those resources is the application obliged to release the resource(s). If that application is a live session, the live session will typically alert the viewer that a scheduled recording is about to take place and the tuner in use will be re-assigned. The user may alternatively be given the option of terminating the scheduled recording and retaining use of the resource.

### SUMMARY OF THE INVENTION

In the multi-session environment, an improved implementation allows reservation of a class of resources with actual assignment of specific resources at the time of need. For example, three previously scheduled recordings may each require one of three tuners in a HAN at 8:00 pm. At 7:59 pm, there may already be two previously initiated recordings and two live sessions in progress. The CRM may assign the tuner from either one of the live sessions as the new 8:00 pm (assuming other resources in the pipeline are available) recording initiates. The CRM may make a determination of which session is lower priority and attempt to assign the resources from that session to the scheduled recording. A determination of lower priority may be made based on parameters such as the live session that was least recently active (based, for example, on remote-control activity in connection with that session), a lower pre-set priority of display, or may be made randomly. Other ways of assigning a priority to a live session will be apparent to those skilled in the art based on the present disclosure.

The CRM may then communicate to the lower priority session that the resources for that session are being revoked. The CRM may also facilitate negotiation for resources and provide a list of alternative sessions with suitable resources. The session may also present to the user options such as deleting the scheduled recording or choosing another live session to terminate.

One aspect of interest in embodiments provides the user a list of resource-dependent events and allows the user to choose from among this list, where at least one event specifies the location of the event.

### BRIEF DESCRIPTION OF THE DRAWINGS

The accompanying drawings, which are incorporated in and form a part of the specification, illustrate the present invention and, together with the description, serve to explain the principles of the invention. In the drawings:

FIG. 1 illustrates an exemplary display for user interaction for controlling resource assignment;

FIGS. 2a and 2b illustrates an exemplary User Interface alert screen;

FIG. 3 illustrates an exemplary user interface screen 300 that allows a user at set-up time to label display sessions;

FIG. 4 illustrates an exemplary user interface screen 400 that may be displayed on a display device if a tuner for a session involving the display device was reallocated to another live session;

FIG. 5 illustrates an exemplary method in accordance with the invention;

FIG. 6 illustrates an exemplary operation in a household to illustrate the principles of the invention;

FIGS. 7 and 8 illustrate exemplary implementations of a user's display devices;

FIG. 9 shows an exemplary an arrangement of a computer which may be used to implement the principles of the present invention; and

FIG. 10 depicts an exemplary home area network (HAN) 10 in accordance with the principles of the invention.

### DETAILED DESCRIPTION OF EMBODIMENTS

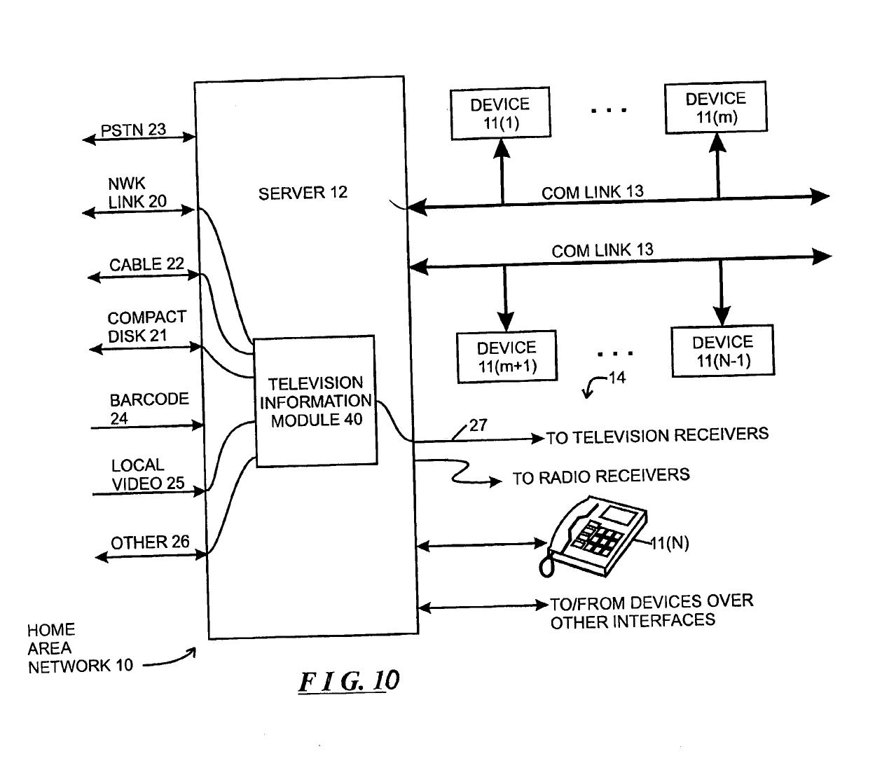

FIG. 10 depicts an exemplary home area network (HAN) 10 in accordance with the principles of the invention. The HAN 10 preferably includes an arrangement for providing television programming information to television receivers over cable connection that is local to the home area network. Generally, the HAN 10 facilitates the connection of a plurality of household appliances, devices, television and radio receivers, telephone sets, and other facilities (generally “devices”) 11(1) through 11(N) (generally identified by reference numeral 11(n)) to a home server 12 over one or more digital communication links generally identified by reference numeral 13 and one or more analog communication links generally identified by reference numeral 14. The home server 12 can also connect to a number of external connections, including a central office in the public switched telephony network (PSTN) over a PSTN link 23, a network such as the Internet over a network link 20, a cable connection (for use in providing cable television, telephony, Internet and other services as will be apparent to those skilled in the art) over cable link 22, a compact disk player over a compact disk link 21, a barcode reader over barcode link 24, a local video source 25, and perhaps other devices (such as devices providing information via satellite and the like, home security devices, and so forth) over other links generally identified by reference numeral 26.

Devices 11(n) preferably can transfer information among themselves over respective communication links 13 or 14 to which they are connected. In addition, the devices 11(n) preferably can transfer information to devices connected to another communication link 13 or 14, respectively, and between the devices 11(n) and the PSTN, network, cable, etc., through the server 12. In that operation, if one device 11 (n′) is connected to an analog communication link 14 and another device 11(n″) is connected to a digital communication link 13, the server 12 can perform a digital to analog or analog to digital conversion as necessary. In addition, the server 12 operates to store information received from the PSTN, network, cable, and devices 11(n) for later transmission over the PSTN, network, cable, etc., and later transmission to the devices 11(n). The information transferred over communication links 13 is preferably in digital form, as is the information stored on the server. On the other hand, information may be transferred over other connections in digital or analog form as appropriate.

The devices 11(n) that can be connected to the home area network 10 can include a number of types of appliances, including but not limited to devices such as personal computers, personal digital assistant (PDA) devices, telephony devices (illustratively device 11(N)), and home entertainment devices such as radio and television receivers, DVD, compact disk, video and audio tape and record players, and the like. In addition, devices 11(n) that can be connected to the home area network can include lighting, heating and cooling, and similar systems, as well as appliances such as stoves and ovens. If a particular device is a “legacy” device, that is, a device that itself does not have an interface that can be connected to a digital communication link 13, that legacy device can be provided with a suitable interface to allow it to be so connected.

Generally, the home area network 10 operates to allow information to be stored on the server 12, transferred among the devices 11(n), and transferred from or to a number of external sources or destinations, including, for example, sources or destinations over a network such as the Internet or the public switched telephony network (PSTN), cable or satellite television or radio, music sources such as compact disks. The information may comprise any form of information, including, for example, audio information, image and video information, information in text form, control information for, for example, controlling one device from another or from the server 12 in relation to, for example, occurrence of certain events, computer programs, and so forth. The home area network can be used to, for example, transfer audio information from sources to destinations such as the server 12 for storage or to various devices 11(n) for playing. Similarly, the home area network 10 can be used to transfer image or video information from sources to destinations such as the server 12 for storage or to various devices 11(n) for display. In addition, the home area network 10 can be used to transfer control information to control controllable devices, such as lighting, appliances such as stoves and ovens, heating and cooling systems, alarm systems and the like.

Communication links 13 may be in any form, including a hard link such as a wire, optical fiber or other arrangement for transferring electrical, optical or other signals among the appliances. Alternatively or in addition, communication links 13 may comprise wireless links, such as but not limited to infrared links or links provided by signals in other parts of the electromagnetic spectrum. Communication links 13 may comprise communication links specially provided for the home area network 10, and/or they may include preexisting links such as telephone lines, wiring provided for, for example, AC power distribution, and the like.

Each device 11(n) connected to a digital communication link 13 may include or be provided with an interface (not separately shown) that enables it to transmit information, in the form of message packets to, and/or receive information in the form of message packets from each other and the home server 12 over the respective communication link 13. When a device 11(n) receives message packets containing information, it can use the information as described below.

Server 12 preferably includes a number of components (not separately shown), including components for processing, storing and retrieving data in digital form, and for converting data between digital and analog form. Server 12 may convert an analog input signal into a digital signal and provide the digital signal to devices 11. Server 12 may also store the converted digital signal. Home server 12 preferably includes a television information module 40 to provide television program information to the one or more television receivers that are located in, for example, the home that includes the home area network 10. The television program information provided by the television information module 40 may be in digital form, in which case it may be distributed over, for example, one or more of the communication links 13 to devices 11(n). Those of the devices 11(n) that are capable of displaying one or both of the video component and/or audio component of the television program information can, under control of a user, receive the information and display and/or play the respective component. Instead or in addition, the television program information provided by the television information module 40 may be in analog form, in which case it may be transmitted over local cable connection 27 to, for example, television receivers (not separately shown), that may be located in the home that includes the home area network 10. As a further alternative, the television program information provided by the television information module may be broadcast as a low-power wireless signal that can be received by a nearby television receiver.

The television program information provided by television information module 40 may originate from a number of sources. For example, the television information module 40 may receive television program information, comprising one or both of the video and/or audio components, from a cable provider, satellite connection or the like over the cable link 22. The television information module 40 may also receive television program information over, for example, a network such as the Internet over the network link 20. The television information module 40 may also receive video information, which will include the video component and may also include the audio component of video program information, over local video link 25. The audio information received over the compact disk link 21 may also be provided to the television information module 40, which may use the audio information as the audio component of video program information.

The television information module 40 may also receive miscellaneous image information from a number of sources that it may use as the video component of television program information provided to the television receivers. For example, the miscellaneous image information may be in any convenient image format, such as the well-known JPEG, GIF or bitmap formats, which the television information module 40 can process to convert as necessary to a form in which it can be used as video program information for provision to the television receivers.

Television information module 40 may also receive textual information, which it can process to convert to a form which can be used as video program information for provision to the television receivers. For example, the textual information may be in the form of Web pages encoded in HTML form, Emails, or other textual information that may be received over, for example, network link 20. The textual information may also be in the form of digital books which may be received over the network link 20, compact disk link 21, or other links 26. Textual information may also be generated by the server 12 itself, and may include, for example, notifications regarding changes of status of security alarm systems, notifications of incoming telephone calls and notifications of other occurrences as will be apparent to those skilled in the art. The television information module 40 may also receive other forms of information which it may use as video programming information to be provided to the television receivers, as will be apparent to those skilled in the art.

In addition to receiving television program, information and providing it to the television receivers, the television information module preferably 40 can store television program information for later retrieval, as, for example, a video recorder.

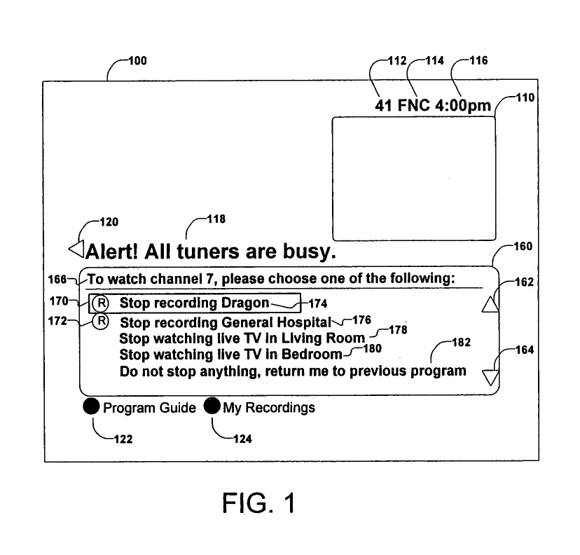

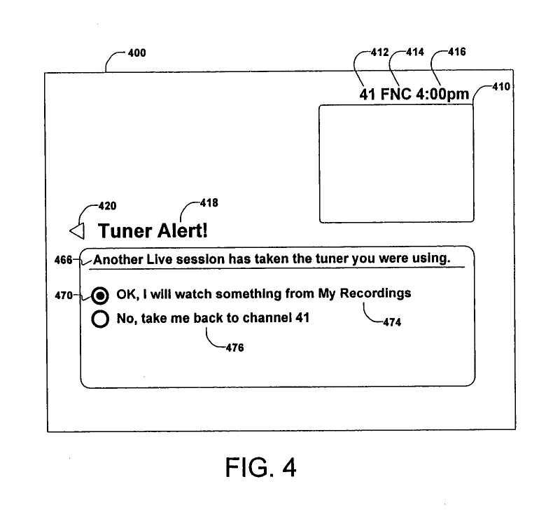

FIG. 1 illustrates an exemplary display for user interaction for controlling resource assignment. In the case of a user attempting to tune to live TV to establish a live session, an alert 100 may be displayed on the display device for that user warning the user that all tuner resources are already in use, and informing the user that a live session may be established only by first freeing a tuner from one of the preexisting tasks (e.g., a preexisting media pipeline in the reservations database of the CRM). The user may be presented with a list of tasks 174, 176, 178, 180, 182 through which the user may navigate using the up/down keys of the remote to highlight the desired selection with a highlighted bounding box 170 or with text highlighted in a different color. In an embodiment, live session entries are listed in a prioritized manner such that the first item listed is the least recently active, or otherwise lowest priority session. If the user elects to terminate another live session, the screen of that session may display an alert similar to the one depicted in FIG. 4.

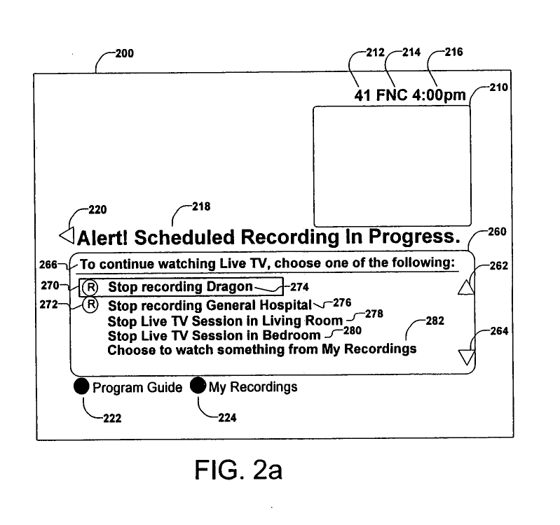

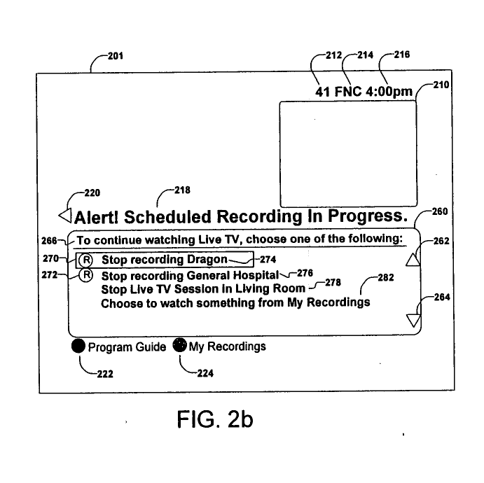

FIG. 2a illustrates an exemplary User Interface alert screen 200 that alerts the user that the current live session has been (or is about to be) interrupted by a pre-scheduled recording. A Picture In Graphic (PIG) display may continue to display the ongoing live session during display of the alert screen, which may precede the actual revocation of the resources being used in the session. The user may also be presented with a dialog box 260 prompting for input from the user. The user may be presented with a list of actions based on active tasks 274, 276, 278, 280, 282. The user may select a task by highlighting the task. The highlighted task will typically be either highlighted in a different color, or highlighted with a bounding box 270. In the illustrated example, the user is engaged in a live session in the Family Room and the tasks displayed represent tasks vying for tuner resources in a four tuner environment. The user may choose to terminate or cancel one of the scheduled recordings 274, 276 that are indicated with a recording icon 272. The user may also choose to terminate or cancel another live session 278, 280. In an embodiment, the tasks relating to live sessions are provided in order of priority so that the first entry listed is the least active session and the one that is most likely not being actually watched.

The user is also presented with the option to terminate the current local live session 282 and switch to watching pre-recorded content from the recording library. If no user input is received within a certain time-out period, the tuner may be assigned to the pre-recorded session and the current live session will be terminated. This may be the likely outcome in a case where the current live session is unattended and/or the display device is turned off.

In an embodiment and in the example being discussed, if the user makes a selection terminating or canceling another live session 278 or 280, the application at the selected session will present a similar screen to 200, with only four choices. For example, if the user chooses “Stop Live TV session in Bedroom,” the screen illustrated in FIG. 2b will be displayed in the bedroom. In an embodiment, the user in the bedroom is not presented with the choice of canceling or terminating live TV in the Family Room; since the user in the Family Room confirmed his desire to retain the tuner resource for the Family Room live session, the user (if any) in the bedroom will not be provided with the option of terminating the Family Room Session. If the user interface request screen 201 times out in the bedroom without a choice being made by the user in the bedroom, the resources for the bedroom session may be released. In another embodiment, if a user in the bedroom chooses the option “Stop Live TV session in Living Room,” a screen similar to 201 will be displayed in the Living Room with no options displayed for stopping any live TV sessions.

Although the required resource class in the example discussed above comprises tuners, a similar dialog interaction may be established if two or more tasks are vying for other resources such as network bandwidth. Moreover, while the tuner resources in the above example were treated as being equal, embodiments of the invention may also be used in situations where resources, such as the tuners, are not treated as having equal priority. For example, if only two tuners in a four tuner household are high-definition capable tuners, then the CRM and dialog screens may only list tasks competing for the high-definition capable tuners.

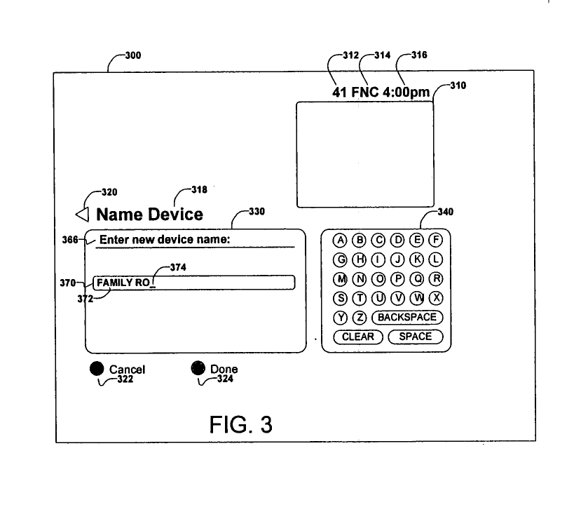

FIG. 3 illustrates an exemplary user interface screen 300 that allows a user at set-up time to label display sessions. The user is presented with a text entry field 370 for entering the label of the display device. A “soft keyboard” 340 may be provided to allow the user to input letters for the labeling, using the up/down/left/right keys of the remote control to highlight a letter and the select key to enter that letter into the text field. In an alternative embodiment, or in addition to user interface screen 300, a user interface screen may be displayed to allow a user to select from a list of preexisting labels for the display device.

FIG. 4 illustrates a user interface screen 400 that may be displayed on a display device if a tuner for a session involving the display device was reallocated to another live session. The screen may provide a radio button dialog box allowing the user to choose a new action by highlighting the appropriate radio button 470, 472. If the user selects to watch content from the My Recordings library, no further tuner resource negotiation is necessary. If the user selects to return to the previously watched channel 476, the user will then be presented with a screen similar to that depicted in FIG. 1 allowing the user to select which task to pre-empt to obtain the resources necessary for the requested live session.

A live stream may be established as a real-time reaction to a user input. For example, a user may selects “Monday Night Football” from the electronic program guide (“EPG”) to “watch live”. An application requests resources to establish a media pipeline: Tuner−>Disk−>Decoder(−>Display). If the resources are not available (e.g. all being used by scheduled recordings) the user will be prompted (e.g. “Would you like to cancel one of these recordings: X,Y,Z”). If resources are currently available, the pipeline will be established. In an embodiment, this may be true regardless of whether a resource conflict is anticipated: (User tunes to MNF at 9:32 pm, but recordings scheduled to kickoff at 10:00 pm will create resource conflict). At some time prior to 10:00 pm (e.g. 9:55 pm) the user interface (“UI”) application may warn the user that a scheduled recording requires that the current viewing of MNF will be interrupted in 5 minutes unless the user cancels one of these events: X,Y,Z. The CRM may choose among a number of live sessions and prioritize which one to flash the warning to. A CRM may determine which live stream is not actually being watched based on user interaction. A CRM may also determine which session is not being watched by passive or active sensing of the TV or control of the TV, as disclosed in the above applications. In embodiments, pre-recorded sessions may be prioritized over live sessions. In these embodiments this is to prevent missing a scheduled recording because someone left the television watching a show, but nobody was around to provide user input to cancel the live session to allow the recording to kickoff.

In some implementations, if the system makes an initial guess as to which session to terminate that is not desirable to the user, the user may intervene and specify through the UI that the system should terminate another live session. The user intervention may be done explicitly, e.g., the user may specify the termination of the bedroom session, not session initially selected. The user intervention may be done implicitly, e.g., the CRM may first select another live session, if such a session is active at that time, to terminate. The CRM may then select the next live session, if it exists, that is most likely to not be watched at that time and prompt the corresponding display device. If no user input is provided, the CRM may terminate that session and reallocate the resources corresponding to the associated media pipeline. If all live sessions but one have been processed in this manner, the display device for the remaining session may not be given the option and instead, that display device may display a UI asking the user to input a decision as whether to terminate a scheduled recording or that live session.

Scheduled recordings may be prioritized by a CRM according to a predetermined criteria, for example by classifying programming in according to metatags associated with the programming in an EPG. For example, the user may specify that all scheduled recordings of live football games are to have the highest priority. Alternatively, prioritization may be achieved with a predetermined, prioritized list that may be displayed to the user, or that may be modified by the user. The user may, for example, change the priority of a program scheduled for recording by moving that item up in the list, and may decrease priority by moving the item down the list.

The CRM may provide a time usage indication and determine when a program is expected to deviate from its expected duration. In an exemplary embodiment, the CRM may detect (or receive an indication that another resource of the HAN has detected), based on a flag passed as metadata in the media stream from the service provider that a football game that is being recorded through a scheduled media pipeline gone into or is going into double-overtime. For example, a recording application may monitor such metadata in the video stream or from an external source. When a flag indicating an event extending the duration of the program is received in this metadata, the application may request that the CRM provide the resources for extending the duration of the scheduled session. The CRM may then determine whether the corresponding media pipeline may be amended accordingly, or whether to create a new media pipeline to fulfill this request.

Because live sessions may be open ended, the time-usage indication that is stored by the CRM with a representation of the live session media pipeline may indicate indefinite time usage. In scheduling determinations, the CRM may consider that indefinite time usage as indicated by the time-usage indication associated with a media pipeline indicates that the resources represented in the media pipeline are not otherwise available. Alternatively, the CRM in attempting to construct future media pipelines may initially attempt to construct those media pipelines without utilizing resources in a preexisting live session media pipeline that conflict (based on the associated time-usage indication) with the time usage indications of the future media pipelines. For example, the prioritization schemes discussed above may be utilized in such embodiments.

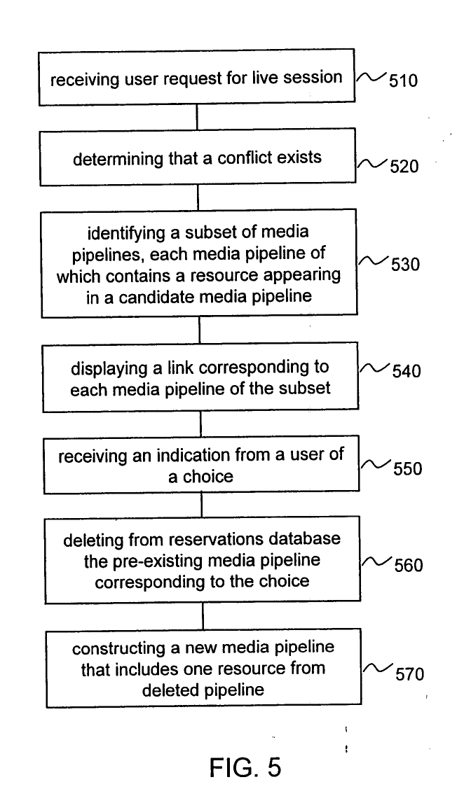

FIG. 5 illustrates an exemplary method of the invention. The steps in this method embodiment may be performed, for example, by a CRM in a HAN. In step 510, a user request for the rendering of a program or other media data is received. For example, the user may request at 8 pm that a hockey game being broadcast on network TV be displayed in a live session on a particular display device. The user may, for example, enter such a request through a remote control device or through the particular display device (or a local resource manager thereof), which may then be communicated to the CRM. In step 520 of the embodiment shown in FIG. 5, the CRM determines that a conflict exists between the user's request and preexisting entries in the reservations database in the CRM. The CRM may first determine that it is unable to fulfill the user's request based on the resources that are available to it and not otherwise reserved at the time of the user's request for a live session. The CRM may additionally determine whether use of any of the resources that are already reserved at that time, for example, the resources represented in preexisting media pipelines represented in the reservations database would be helpful in fulfilling the user's request. The CRM may construct candidate media pipelines for fulfilling the user request under an assumption that all resources of the HAN are available to it. In the example given, the CRM may determine from an electronic program guide that the hockey game is being shown on a particular channel on broadcast TV at 8 pm. The CRM may also determine that the display device used by the user at step 510 is the display which should be used to display the hockey game. The CRM may thus determine that a candidate media pipeline includes any tuner in the HAN (even if already reserved for the time associated with the user's request) and the display device used at step 510.

In step 530 of the embodiment shown in FIG. 5, the CRM identifies a subset of the preexisting media pipelines of the reservations database whose associated time-usage indications indicate a conflict with the user request of step 510, and which each include at least one resource represented in a candidate media pipeline as determined in step 520. In step 540, the CRM displays or causes the display of a link for each of the preexisting media pipelines of the subset identified in step 530. The CRM may, for example, cause the local resource manager of the display through which the user entered the user request of step 510 to display a GUI with a listing of these links. The user may further be prompted to select at least one of these links for termination by the further display of a text message to this effect.

In step 550, the CRM receives an indication from the user of his choice regarding the link selected for termination. The user may, for example, use a remote control unit to move through the displayed links and highlight the one the user wishes to terminate, and then press an enter key on the remote control. The local manager for the display device may then transmit this selection to the CRM. In step 560, the CRM deletes from the reservations database the preexisting media pipeline corresponding to the user's choice in step 560. The CRM by doing this thus frees the resources represented in that media pipeline for the time or time period identified by the time-usage indication associated with that media pipeline. In step 570, the CRM constructs a media pipeline for fulfilling the user request, with the constructed media pipeline including a representation of at least one resource that had been represented in the preexisting media pipeline deleted in step 560. The CRM may then fulfill the user's request by implementing the newly constructed media pipeline.

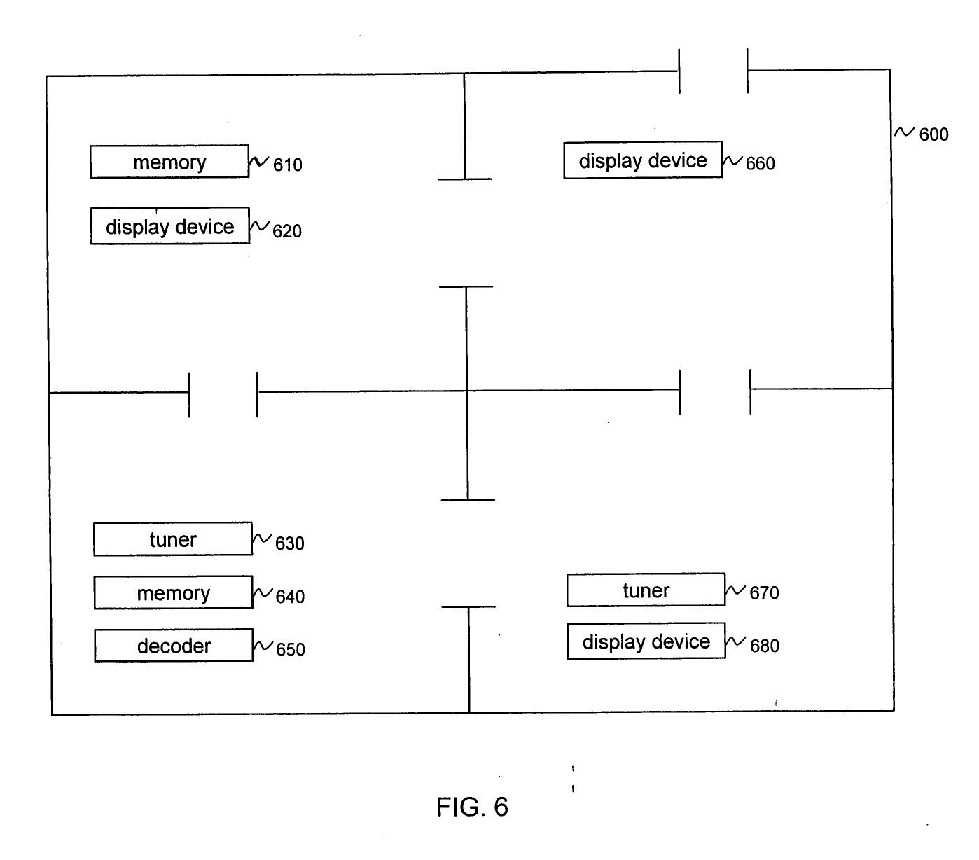

It is illustrative to consider an example of the embodiment discussed above. Example HAN of FIG. 6 includes in a first room of customer premises 600 memory 610 and display device 620; in a second room tuner 630, memory 640 and decoder 650; in a third room display device 670 and tuner 680; and in a fourth room display device 660. In the example, the user at 8 pm requests that a hockey game being broadcast on network TV be displayed in a live session on display device 660.

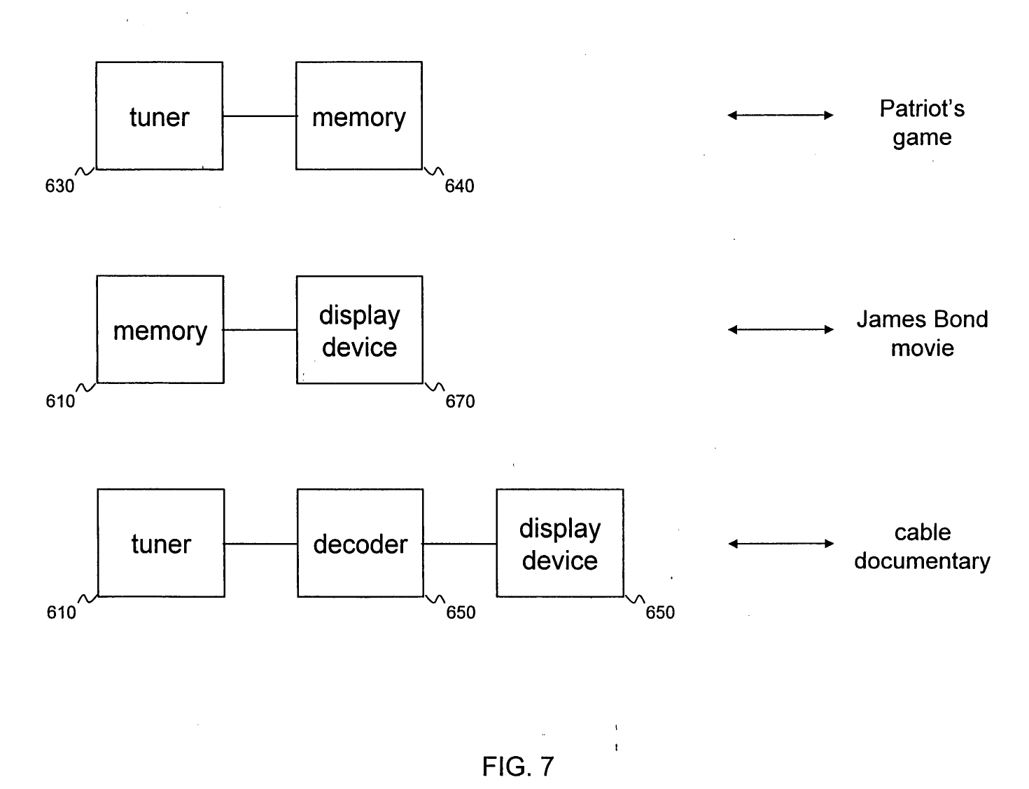

FIG. 7 shows the preexisting media pipelines in the reservations database in the example being discussed. First, the reservations database contains a representation of a preexisting media pipeline corresponding to the recording of a Patriots football game to memory 640. This media pipeline includes tuner 630 and memory 640, and is further associated with a time-usage indication that overlaps or otherwise conflicts with the user's request for an 8 pm live session. The reservations database also contains a representation of a preexisting media pipeline corresponding to the playback of a pre-recorded James Bond movie from memory 610 to display device 670. In the example, this media pipeline is also associated with a time-usage indication that overlaps or otherwise conflicts with the user's request for an 8 pm live session. The reservations database also contains a representation of a preexisting media pipeline corresponding to a cable documentary being streamed to display device 620. This media pipeline involves tuner 680 for tuning into the relevant cable channel and decoder 650 for decoding or descrambling the cable signal. In the example, this media pipeline is also associated with a time-usage indication that overlaps or otherwise conflicts with the user's request for a 8 pm live session.

The CRM in step 520 of the embodiment shown in FIG. 5 may determine that a conflict exists based on its inability to find an available tuner in the HAN for tuning into the hockey game at 8 pm. Part of this step may include the determination of the types of resources needed to fulfill the user's request in this case, the CRM identifies only a tuner and a display device as being needed, because the hockey game is being shown live on broadcast TV, and no DVR or live pause functionality was requested as part of the user request.

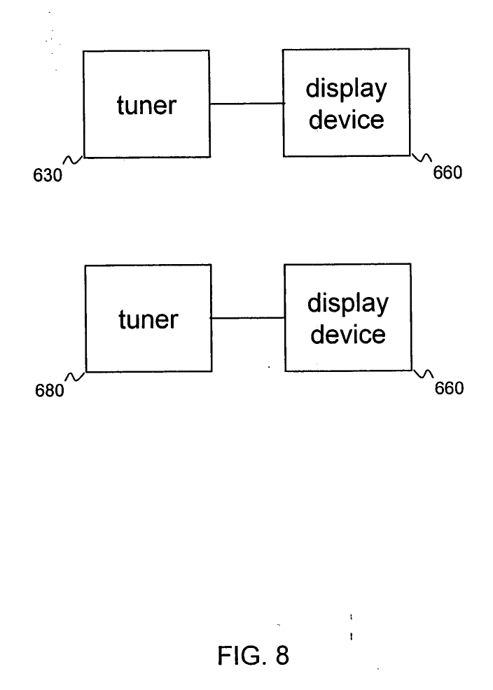

As apparent from FIGS. 6 and 7, the example HAN does not contain any available tuners at the time when the user has requested to view the hockey game live. The CRM in step 530 may then identify a subset of the preexisting media pipelines that contain a resource that could be used to fulfill the user request of step 510. As part of step 530, the CRM may first identify a set of candidate media pipelines that could be used to satisfy the user's request, assuming no conflicts existed with the reservations database. The CRM in determining a set of candidate media pipelines may treat all resources in the HAN as being available. In the example, because only a tuner and display 660 would be needed to fulfill the user's request to view the hockey game, the set of candidate media pipelines will only include media pipelines including a tuner and display 660. FIG. 8 shows the two candidate pipelines of the example: the first candidate media pipeline includes tuner 630 and display device 660, whereas the second includes tuner 680 and display device 660.

In step 530, the CRM then identifies those preexisting media pipelines containing a resource that is needed to fulfill the user's request and that appears in at least one of the candidate media pipelines. In the example being considered, the CRM identifies the preexisting media pipelines corresponding to the Patriot's game and the cable documentary, because each of these preexisting media pipelines contains a tuner, which is a required resource that is otherwise unavailable because of the conflict and which appears in the candidate media pipelines of FIG. 8. The CRM in step 540 of the embodiment of FIG. 5 may then display or cause to display on display device 669 a GUI containing a link corresponding to the media pipeline for the Patriot's Game, a link corresponding to the cable documentary, and a message warning the user of a conflict and asking the user to either select one of the displayed links for cancellation, or to cancel the user request of step 510, in this example, to view the hockey game. If the user selects one of the links, then the CRM will delete the corresponding preexisting pipeline, which frees the resources represented in that media pipeline at the time or for the time period indicated by the time-usage indication associated with that media pipeline. The CRM may then construct and implement a media pipeline that fulfills the user's request using at least one resource freed by cancellation of the selected preexisting media pipeline. The CRM in this manner may resolve conflicts arising from user requests and preexisting entries in the reservations database in a HAN.

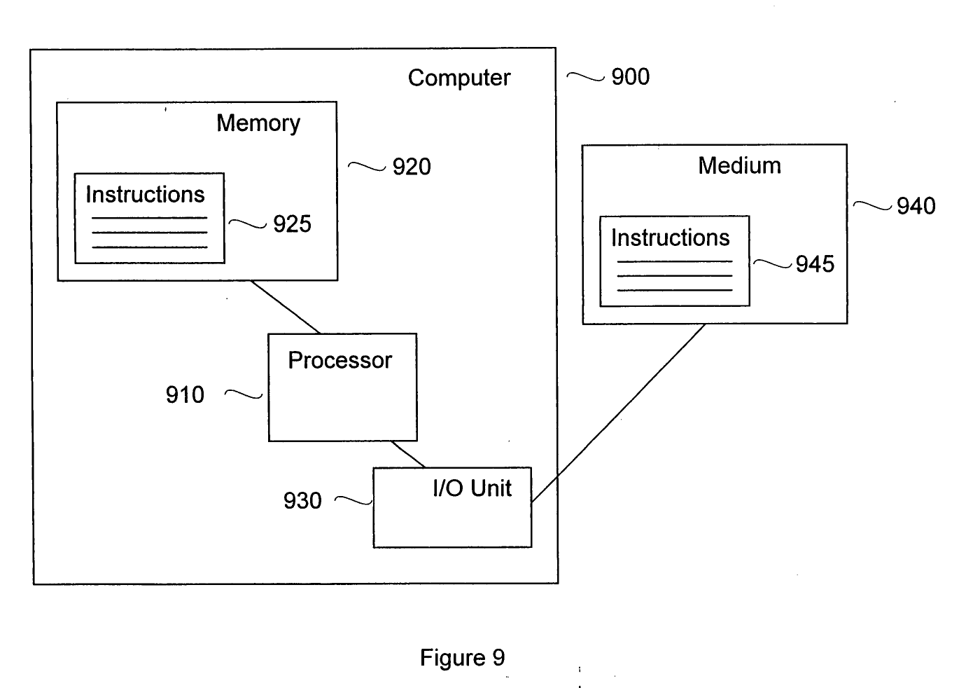

FIG. 9 shows an exemplary an arrangement of a computer which may be used to implement the principles of the present invention. In FIG. 9, a medium 940 containing Instructions 945 may be operatively coupled to a computer 900. For example, instructions 945 may contain the steps in an embodiment of a method of the present invention. In particular, instructions 945 in a specific implementation may comprise the instructions corresponding to the steps carried out by the CRM in FIG. 5. In the example depicted in FIG. 9, computer 900 contains a processor 910 which is coupled to an input/output unit 930 and a memory 920. Memory 920 may also have instructions 925, which correspond to the steps in an embodiment of a method of the present invention. In a specific implementation, instructions 945 of medium 940 may be copied into memory 920.

The invention and the methods of the embodiments may be implemented in software programmed logic, either in software or hardware, as will be apparent to those skilled in the art based on the present disclosure.

The invention may be embodied on a computer readable medium. A computer readable medium may be in the form of a computer storage medium, such as, but not limited to, a RAM, ROM, a computer readable disk, CDROM, tape or removable silicone based memory. A computer readable medium may also of computer readable data, packetized or non-packetized which may be transmitted via wireline, optical link or wirelessly and may be provided via a carrier wave.

Display devices 620, 660 and 680 may each have a local decoder resource (not shown) that is utilized, for example, for decoding MPEG2 (or other MPEG) encoded data. Such a decoder may be a part of a display device, or in an alternative embodiment, may be implemented in a set-top box local to a display device. Moreover, a media server in such a HAN may have a local memory or other storage resource (not shown). Additionally, tuners that are utilized in embodiments of the invention include analog tuners as well as digital tuners. An analog tuner in embodiments of the invention may additionally include an MPEG2 (or other MPEG) encoder (not shown). A tuner in embodiments of the invention may be used to tune to a carrier in the relevant medium in which the media data propagates to the tuner. The tuner may then demodulate media data modulated onto the carrier to extract useful data. Demodulation functionality may be implemented in the tuner resource itself, or an additional demodulator resource may be used in conjunction with the tuner for such functionality. All such embodiments will be apparent to one skilled in the art based on the present disclosure.

It will be appreciated that a system in accordance with the invention can be constructed in whole or in part from special purpose hardware or a general purpose computer system, or any combination thereof, any portion of which may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

Variations to the embodiments discussed above will be apparent to those skilled in the art based on the present disclosure. These variations are within the scope of embodiments of the invention. In a variation of embodiments discussed above, actions discussed above as being taken by a resource of the HAN may be taken by a local resource manager of the relevant resource. Such variations of the embodiments discussed above are within the scope of the present invention.

1. A method in a HAN for resolving conflicts, the HAN comprising a CRM and a reservations database, the reservations database comprising representations of a plurality of preexisting media pipelines, the method comprising:
receiving a user request for a live session;
identifying a conflict between the user request and the plurality of preexisting media pipelines in the reservations database;
requesting an indication from the user to override current access to a predetermined media pipeline; and
overriding current access to the predetermined media pipeline if the user indicates that the current access should be overridden.

2. The method of claim 1, wherein the step of requesting an indication from the user to override current access to a media pipeline, further comprises the step of identifying a subset of the plurality of preexisting media pipelines, each media pipeline of the subset containing at least one resource appearing in a candidate media pipeline for fulfilling the user request.

3. The method of claim 2, further comprising the step of, for each preexisting media pipeline of the subset, displaying a link corresponding to that preexisting media pipeline on a display device.

4. The method of claim 1, wherein the step of overriding current access to a predetermined media pipeline comprises the step of:
receiving an indication of a choice of a particular media pipeline of a plurality of media pipelines to override;
deleting from the reservations database the particular media pipeline chosen; and
constructing a new media pipeline for fulfilling the user request, wherein the new media pipeline includes at least one resource from the overridden particular media pipeline.

5. A computer readable medium containing instructions to cause a computer in a HAN to resolve conflicts, the HAN comprising a reservations database, the reservations database comprising representations of a plurality of preexisting media pipelines, the instruction causing the computer to perform a method comprising:
receiving a user request for a live session;
identifying a conflict between the user request and the plurality of preexisting media pipelines in the reservations database;
requesting an indication from the user to override current access to a predetermined media pipeline; and
overriding current access to the predetermined media pipeline if the user indicates that the current access should be overridden.

6. The computer readable medium of claim 5, wherein the step of requesting an indication from the user to override current access to a media pipeline, further comprises the step of identifying a subset of the plurality of preexisting media pipelines, each media pipeline of the subset containing at least one resource appearing in a candidate media pipeline for fulfilling the user request.

7. The computer readable medium of claim 6, further comprising the step of, for each preexisting media pipeline of the subset, displaying a link corresponding to that preexisting media pipeline on a display device.

8. The computer readable medium of claim 5, wherein the step of overriding current access to a predetermined media pipeline comprises the step of:
receiving an indication of a choice of a particular media pipeline of a plurality of media pipelines to override;
deleting from the reservations database the particular media pipeline chosen; and
constructing a new media pipeline for fulfilling the user request, wherein the new media pipeline includes at least one resource from the overridden particular media pipeline.

9. An apparatus for managing a plurality of media pipelines for providing media content to a user through at least one device, the apparatus comprising:
an input configured to receive media from at least one media source;
at least one tuner configured to separate media content received from at least one media source;
a controller configured to receive selections of desired media content from a user and control the at least one tuner to separate predetermined media content selected by a user, the controller being configured to determine if two or more user selections require utilization of the same media pipeline and to redirect selected content to the media pipeline based upon an indication from the user to override content already on the media pipeline.
